(19) United States
(12) Patent Application Publication
(10) Pub. No.: US 2011/0274867 A1
(43) Pub. Date: Nov. 10, 2011

(54) Article produced by the two-component injection-moulding process

(76) Inventors: Guenter Pohlmann, Lohne (DE); Alfons Boeckmann, Dinklage (DE)

(21) Appl. No.: 12/311,140

(22) PCT Filed: Sep. 22, 2006
(86) PCT No.: PCT/EP2006/066647

§ 371 Date: Aug. 28, 2009

(51) Int. Cl. B32B 3/08; B44C 1/00; B32B 15/08; B29C 45/14; B32B 37/24

(52) U.S. Cl. 428/67; 264/259; 156/242; 428/68

(57) ABSTRACT

The invention relates to an article (1) produced by the two-component injection-moulding process. To improve further an article of the type in question, in a way that is technically simple in production terms, with regard to the visual design and/or with regard to security or identification features that are to be provided, it is proposed that an insert (7) is arranged in the parting surface (6) between the components, or that one of the layers (2, 3) is provided with an imprint in the parting surface (6), or that one of the layers (2, 3) has a formation similar to an engraving in the region of the parting surface (6).

The invention first of all relates to an object produced using the two-component injection-molding method.

Such objects are known and find use, for example, in the sector of foods packaging, or storage containers or lids for them, such as those for cosmetics and/or pharmaceutical products, for example. These consist of two plastic components, which can be injected at the same time to form the object. However, objects are also known in which first one component is injection-molded, and afterwards, the second component is injection-molded over it. The two components can have different forms with regard to their coloring. Objects are also known in which two components made of different plastics were used.

With regard to the state of the art described above, a technical problem of the invention is considered to be further improving an object of the type in question, in terms of production technology, in simple manner, with regard to the optical configuration and/or with regard to security characteristics or identification characteristics to be provided.

This problem is solved, first of all and essentially, by means of the object of claim 1, whereby the important factor is that an insertion part is disposed in the parting surface between the components. In this connection, the parting surface is the plane between the two plastic components, in which these components melt together during the course of the injection-molding that is carried out at the same time or one after the other. According to the invention, an insertion part is disposed in this plane—parting surface. This part can be laid onto the semi-finished product after the latter has been produced by injection-molding a first component, in order to afterwards have the second component injection-molded over it, together with the semi-finished product. Afterwards, the insertion part is permanently captured between the two plastic components. Also, the insertion part, at least in the case of an embodiment in which the two components completely cover the insertion part, in each instance, is protected against stresses that act on it from the outside. Thus, a manipulation of the insertion part, or a replacement of it, cannot be carried out without destruction. The insertion part can be disposed on the top of the first component, which faces the second component, i.e. in the region of the subsequent parting surface. Alternatively, the insertion part can also be positioned on the underside of the first component, facing the additional component to be injection-molded over it, in the region of the parting surface.

The objects of the additional claims will be explained below, with reference to the object of claim 1, but can be of importance also in their independent formulation.

Thus, it is further provided that the insertion part is a label. This label can contain information about the object, i.e. about a medium or the like that is stored in the object, which is configured as a container, for example. Also, this can be a label that contains a product advertisement. At least a first component is injection-molded behind such a label, preferably in the manner of an in-mold label, and afterwards, the second component is injection-molded over the first component and the in-mold label. Also, the insertion part can be an adhesive label, which is fixed in place, after the first component has been injection-molded to form a semi-finished product, on the latter, by means of the self-adhesive layer, and then has the second component injection-molded over it. A further development in which the insertion part is a rigid part, for example a metal part, such as a coin or the like, for example, brings particular optical and/or decorative advantages with it. While a label or an adhesive label or an in-mold label tend to be configured in flexible manner, because of the very slight thickness, in the pin range, which is generally selected, and therefore can go along with a curvature of the parting surface that might be provided, a rigid insertion part, particularly in the case of a curved parting surface, has a three-dimensional effect, since it tends to be set off from this parting surface. Even in interaction with a planar parting surface, the thickness measured perpendicular to the parting surface plane, of a rigid part, such as, in particular, a coin, has an effect. In the case of a parting surface that runs in curved manner, the rigid part can be disposed both in front of the parting surface, tangentially touching it, and behind the parting surface, tangentially touching it, looking from the same direction. As another alternative, the rigid part can also intersect the parting surface, in the manner of a secant. In the case of an inserted coin or another rigid embossed part, in particular, this part can furthermore achieve an optical effect so that a shadow is cast in this manner. Also, the insertion part can be an electrical functional foil, for example in the form of a transponder or other contact-free ID systems, such as a smart label or the like. Such functional foils serve, for example, for anti-theft protection and/or for identification during the course of scanning at the cash register in the case of objects for sale. Here, the embedding of the insertion part between the components that is proposed proves to be particularly advantageous, since this counteracts manipulation. Also, it is proposed that the insertion part is at least partially not covered by at least one of the layers. Accordingly, a window-like opening region can be provided in the covering region, relative to the insertion part. This window-like opening region can be formed both in the region of the object section produced by means of the first component, and in the region of the object section produced by means of the second component. Alternatively, the two half parts can possess such window-like opening in projection toward the enclosed insertion part.

Furthermore, the invention relates to an object according to the characteristics of the preamble of claim 1. In order to further improve such an object in an optical and/or functional manner, it is proposed that one of the layers is imprinted in the parting plane. For example, a semi-finished product produced from a first component can be passed to a printing device, which applies an imprint to the surface over which or behind which material is later injection-molded, which surface subsequently forms the parting plane, for example in the form of a logo and/or in the form of writing.

The invention also relates to an object according to the characteristics of the preamble of claim 1, whereby here, it is proposed, in order to accomplish the task, that one of the layers has an engraving-like formation in the region of the parting plane. By means of this engraving, recessed and elevated regions on the surface that faces the other component are worked free, and these achieve an appealing optical effect, particularly by means of a shadow effect.

The object of the additional claim will be explained below with reference to the object of claim 1 and/or the object of claim 8 and/or the object of claim 9, but can also be of importance in its independent formulation.

Thus, in a preferred embodiment of the object of the invention, it is proposed that at least one of the layers is kept transparent. This at least one layer is preferably the outer layer, which thus gives a view of the embedded insertion part. Alternatively, both layers can also be kept transparent, for example in the case of a beverage container or the like produced according to the invention. The different component layers can also be kept transparent in different colors.

Also, the invention relates to a method for the production of an object using the multi-component injection-molding method. In order to indicate a method of the type in question, by means of which an object having optically and/or functionally improved properties can be produced, it is proposed that first, a component is injection-molded, then the parting surface provided for injection-molding the second component over it is treated in the sense that a part is laid on or glued on, or an engraving or imprinting is carried out, and that then, the parting surface treated in this manner has the second component injection-molded over it, at least in part. In consequence of this embodiment according to the invention, a method is indicated by means of which an object produced using the multi-component injection-molding method can be produced, which object has an insertion part in the parting plane between the components, or in which one of the layers is imprinted in the parting plane, or provided with an engraving. In this method, different components can be used with regard to color, starting material, and/or transparency.

In the following, the invention will be explained in greater detail using the attached drawing, which merely shows several exemplary embodiments. This drawing shows:

FIG. 1 in a perspective view, an object according to the invention, in an exemplary embodiment;

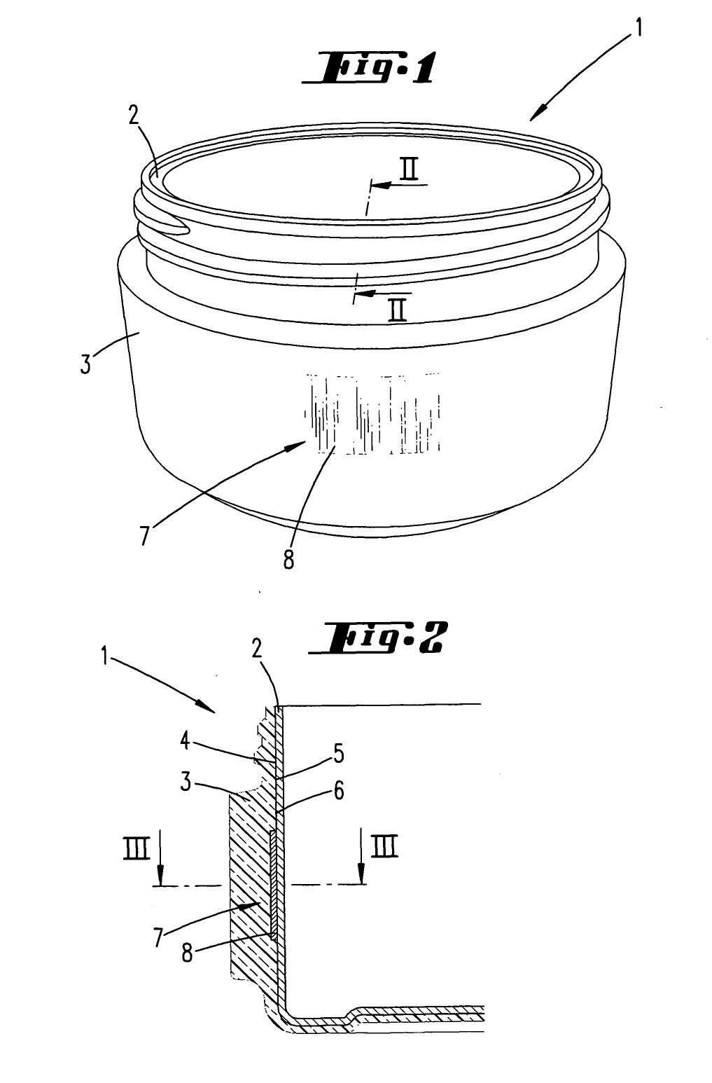

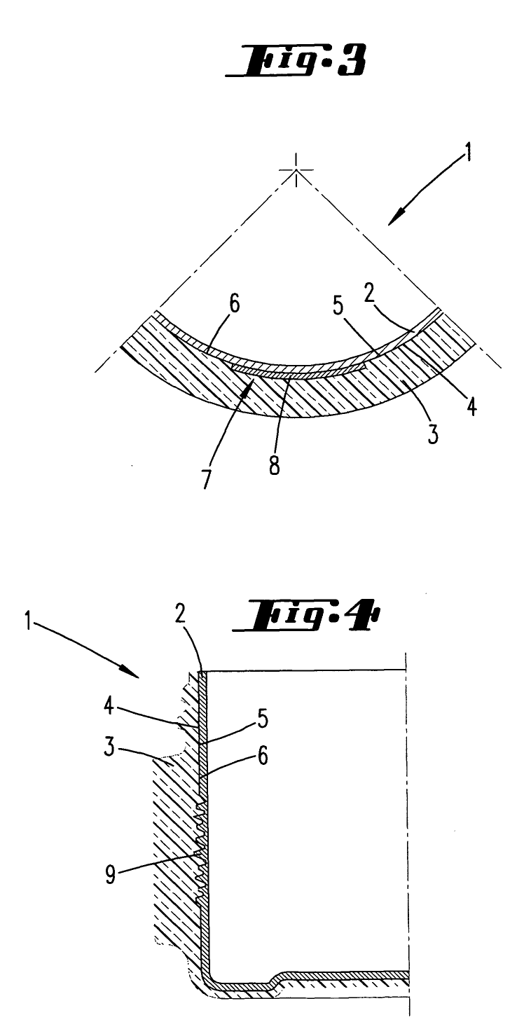

FIG. 2 the section along the line II-II in FIG. 1;

FIG. 3 the section along the line in FIG. 2;

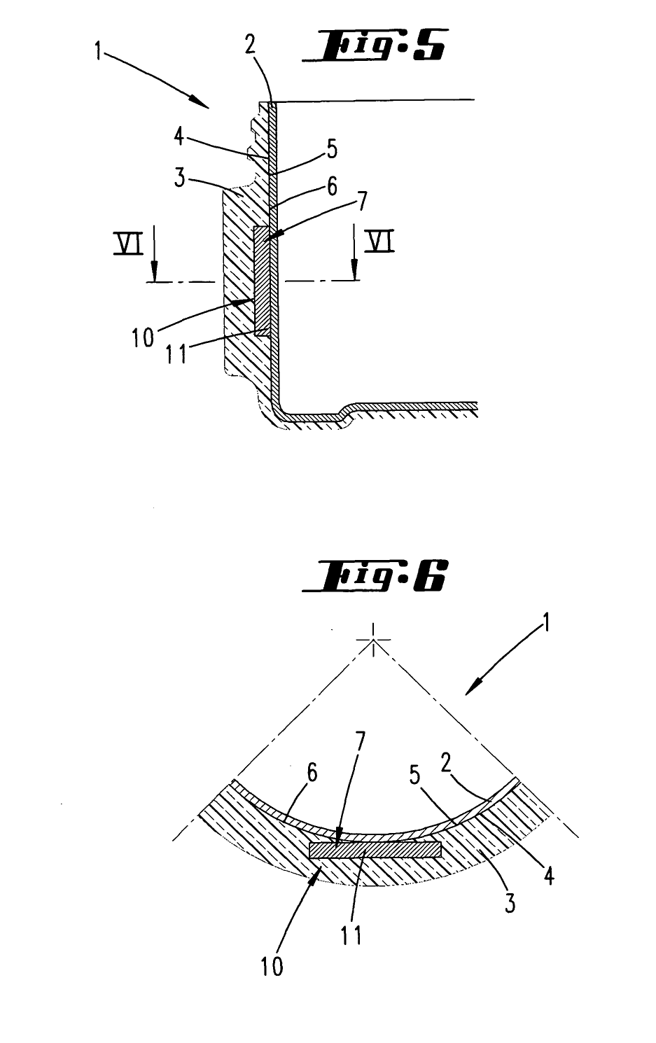

FIG. 4 a sectional view corresponding to FIG. 2, but relating to an alternative embodiment;

FIG. 5 in another embodiment, a representation according to the sectional representation in FIG. 2;

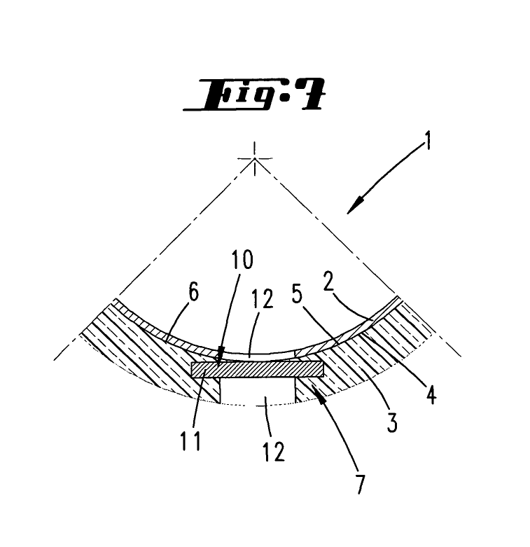

FIG. 6 the section along the line VI-VI in FIG. 5;

FIG. 7 a sectional view corresponding to FIG. 6, but relating to another embodiment.

First of all, an object 1 in the form of a jar having a screw-on lid is shown and described with reference to FIG. 1. This jar is produced using the two-component injection-molding method. Accordingly, the jar 1 has two component layers 2 and 3, whereby a first component layer 2 forms the inner layer on the inside of the jar, and the component layer 3 forms the essentially visible layer, which surrounds the first component layer 2.

The surface 4 of the first layer 2 that faces the second layer 3, together with the surface 5 of the second layer 3 that faces the first layer 2, forms a parting surface 6 between the layers 2 and 3, in which parting plane, formed by this parting surface 6, the components of the layers 2 and 3 are melted together with one another.

An insertion part 7 is disposed in this parting surface 6, according to the representations in FIGS. 1 to 3. This part is a label 8 in the form of an in-mold label, in the exemplary embodiment shown, which label 8 has the component for the first layer 2 injection-molded behind it in the injection mold. Alternatively, this insertion part 7 can also be an adhesive label, which is applied to the first layer 2 that has already been injection-molded, onto its surface 4.

The insertion part 7 has the component for the second layer 3 injection-molded over it, and is thus completely enclosed in the object 1, both on the front and on the back, over its full area.

In this connection, the second layer 3 is preferably kept transparent. Accordingly, the view of the enclosed insertion part 7, which represents a logo, for example, is free.

The insertion part 7 can also be a functional part, for example a functional foil in the form of a transponder or the like. In this connection, it is advantageous if the second layer 3, like the first layer 2, as well, is not kept transparent.

According to the representation in FIG. 4, the surface 4 of the first layer 2 (alternatively, also the surface 5 of the second layer 3) can be provided with an engraving. During the course of injection-molding, the component of the second layer 3 goes into the depressions formed in this manner. If the second layer 3 is kept transparent, this engraving 9 thereby brings about a shadow effect.

As another alternative, the insertion part 7 can be a rigid part 10, as shown in FIGS. 5 and 6, for example in the form of a coin 11. This rigid part 10 has the material of the first layer 2 injection-molded behind it, and finally has the component for the second layer 3 injection-molded over it. Because the second layer 3 is preferably kept transparent, the rigid insertion part can be seen from the outside, whereby the surface structure leads to shadow-casting effects, particularly if a coin 11 is inserted.

As is particularly shown in FIG. 6, the rigid part 10 can be disposed in secant-like manner relative to the parting surface 6, i.e. to the surface 4 of the first layer 2, and this in turn leads to partial placement behind the rigid part 10 of the component of the second layer 3, after the rigid part 10 and the first layer 2 have had this component injection-molded over them. As a result, a further shadow effect on the first, preferably non-transparent layer 2, can be achieved. Alternatively, as shown in general in FIG. 7, the rigid part 10, in the form of a coin 11, can also intersect the parting surface 6 in secant-like manner, so that the rigid part 10 lies in a pocket-like accommodation both of the first layer 2 and of the second layer 3, in each instance.

As can furthermore be seen in FIG. 7, the insert part 7, particularly a rigid part 10, can be at least partially not covered by at least one of the layers 2 and/or 3. An embodiment is shown in which the two layers 2 and 3 cover the insertion part 7 only at the edges, so that window-like openings 12 are formed in projection to the insertion part 7. Not only can the insertion part 7 be seen through the openings 12, but furthermore it can also be touched.

All of the characteristics disclosed are essential to the invention (in and of themselves). The disclosure content of the related/attached priority documents (copy of the prior application) is hereby incorporated into the disclosure content of the application, to its full extent, also for the purpose of incorporating characteristics of these documents in claims of the present application.

1. Object (1) produced using the two-component injection-molding method, wherein an insertion part (7) is disposed in the parting surface (6) between the components, wherein the insertion part (7) has material injection-molded behind it, and wherein the first component, together with the insertion part (7), has a second transparent component injection-molded over it.

2. Object according to claim 1, wherein the insertion part (7) is a label (8).

3. Object according to claim 1, wherein the insertion part (7) is an adhesive label.

4. Object according to claim 1, wherein the insertion part (7) is a rigid part (10).

5. Object according to claim 4, wherein the insertion part (7) is a metal part, such as a coin (11), for example.

6. Object according to claim 1, wherein the insertion part (7) is an electrical functional foil.

7. Object according to claim 1, wherein the insertion part (7) is at least partially not covered by at least one of the layers (2, 3).

8-10. (canceled)

11. Method for the production of an object using the multi-component injection-molding method, wherein first, a label has a first component injection-molded behind it, and then, the first component, with the label, has a second component injection-molded over it, wherein a transparent plastic is selected as is the second component.
